(19) United States
(12) Patent Application Publication
(10) Pub. No.: US 2007/0148362 A1
(43) Pub. Date: Jun. 28, 2007

(54) Spay coating unit and method of spray coating

(76) Inventors: Mikael Furu, Parainen (FI); John Bergman, Ulm (DE); Vilho Nissinen, Numminen (FI); Petteri Lannes, Jokela (FI); Tatu Pitkanen, Jarvenpaa (FI); Rami Vanninen, Kellokoski (FI)

Correspondence Address: COHEN, PONTANI, LIEBERMAN & PAVANE, 551 FIFTH AVENUE, SUITE 1210, NEW YORK, NY, 10176, US

(21) Appl. No.: 10/576,814

(22) PCT Filed: Oct. 28, 2004
(86) PCT No.: PCT/FI04/00637

§ 371 Date: May 16, 2006

(30) Foreign Application Priority Data
Oct. 28, 2003 (FI) U20030402

(51) Int. Cl. B05D 7/00; B05C 5/00; B05B 7/06

(52) U.S. Cl. 427/421.1; 118/325; 118/313

(57) ABSTRACT

The object of the invention is a spray coating unit (1) for treating a moving paper or board web (3) with a treating agent, the spray coating unit comprising an application chamber (P2), through which the web (3) to be treated is arranged to move, the application chamber (P2) containing an inlet port (4) for leading the web (3) into the application chamber (2) and an outlet port (5) for leading the web out of the application chamber (2), and at least one row of nozzles comprising at least one nozzle (6) for spraying the treating agent on the surface of the web (3) in the application chamber (P2). The spray coating unit according to the invention comprises spraying members (15) for spraying water mist into the application chamber (P2).

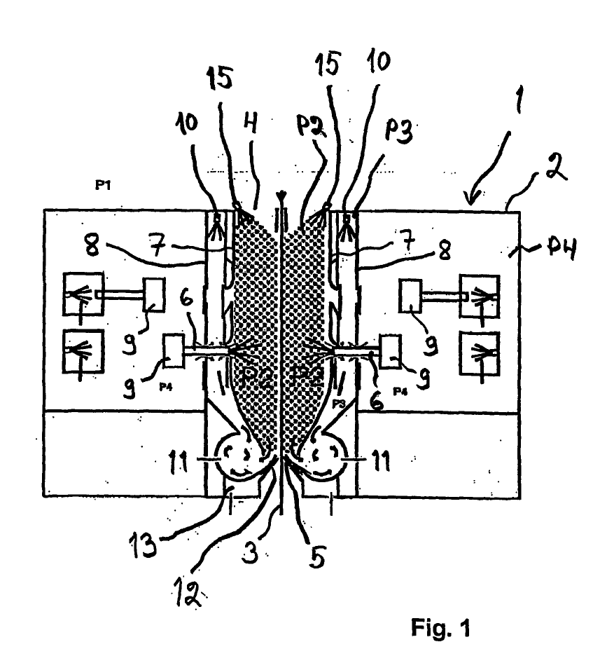

The invention relates to a spray coating unit according to the preamble of claim 1 for treating a moving paper or board web with a treating agent. A spray coating unit of this type comprises an application chamber, through which the web to be treated is adapted to move, and at least one row of nozzles comprising at least one nozzle for spraying the treating agent on the surface of the web in an application chamber.

The invention also relates a method for treating the moving paper or board web with a treating agent.

Currently, various methods are used for coating paper and board. Each coating method has its own special features, which affect the quality of the end product and the manufacturing process. In terms of manufacturing techniques, the coating method is selected in accordance with the needed production rate and the strength of the web, among other things. The quality factors of the end product are determined according to the use of the product, i.e., in practice, according to the printing method that is to be used for the product and how good a final printed surface is to be manufactured. Generally, to achieve good printability, a suitably smooth and even surface is needed, which is very white. These properties are achieved by using a sufficient number of coating layers and by calendaring the web, which is manufactured, in the various stages of the manufacture. Naturally, an increase in the processing stages increases the price of the product; therefore, the selection of the manufacturing process is primarily determined by the desired properties of the end product. When the appropriate process for the end product has been selected, methods of treatment are selected which provide the best result from the point of view of production and the quality of the end product.

One promising coating method is spray coating, wherein a coating mixture or some other treating agent is sprayed on the surface of the paper or board using high-pressure nozzles. In this method, the treating agent is pressurized into a high pressure and sprayed on the web from a small nozzle at a high velocity. One advantage of the method is that it hardly stresses the web, which is why the runnability of the spray coating equipment is good. A completely non-contacting surface treatment is more gentle compared with the blade coating or film transfer coating currently used, and the smaller stress on the track enables a growth of about 5% in production efficiency compared with blade coating. On the other hand, the web can be manufactured of a weaker pulp, which is of benefit in using recycled fibre in particular.

When using contacting coating, such as blade coating, a gap remains between the web's surface and the member limiting the coat weight, the gap determining the coat thickness. This is one of the reasons why the obtained coat weight is tied up to the quality variation of the base paper, such as profile variations and roughness variations. In spray coating, the equipment always provides the web with a certain layer of coating in spite of quality variations in the base paper. In addition, spray coating can be made on a moister and thus weaker web than before. Spray coating is described, for example, in publication EP 856 084.

As the coat mix, the surface size or some other treating agent in spray coating is spread on the web as a jet of drops, which in a free space flies over the distance between the tip of the nozzle and the web to be treated, a problem of the coating mist spreading into the ambient air occurs in a practical coating process. Accordingly, the spray nozzles must be placed in a casing. The mist of treating agent condensates on the surfaces of the application chamber of the casing, from where it must be collected and the entry of large condensed drops to the web must be prevented. Neither should any condensed treating agent be allowed in the spray jet. The surfaces of the application chamber are cooled down to a temperature below the condensation point of the condition prevailing in the application chamber. In that case, treating agent is condensed from the mist on the cooled surfaces, flowing downwards along the surfaces. The flowing liquid film collects mist and prevents the treating agent from drying or solidifying into a solid matter on the surface of the plate. The condensation point is the higher, the moister the air in the application chamber is. To increase the condensation point, solutions have been developed, wherein humid, moisturized air or steam is blown into the application chamber.

In solutions, wherein moist air is blown into the application chamber, the coating unit must be provided with an air humidifier, which increases the price of the equipment. Drops of coating mixture are also formed in the air nozzle, which drops may drip onto the surface of the web. Furthermore, the air blowing increases the pressure in the application chamber, whereby some mist of the coating mix may leak into the machine room.

If steam is blown into the application chamber, the equipment must be provided with a steam generator, which increases the equipment and operation expenses of the coating unit. In addition, the steam increases the thermal stress of the application chamber, which in turn increases the surface temperatures of the application chamber and thus decreases the condensation of the mist of coating mixture on the surfaces.

The purpose of the invention is to provide a new kind of a solution, which can be used to improve the condensation of the coating mix mist on the surfaces of the application chamber of the spray coating unit.

The invention is based on the fact that the moisture content of the air in the application chamber is increased by spraying fine water mist into the application chamber. The water mist is sprayed with spraying members, such as a nozzle or nozzles, which are preferably fitted in the vicinity of the inlet opening of the web. In one preferred embodiment of the invention, the average drop size of the water mist to be sprayed is 150 μm at the most, preferably 50 μm at the most.

More specifically, the spray coating unit according to the invention is characterized by what is stated in the characterizing part of claim 1.

Furthermore, the method according to the invention is characterized in that which is stated in the characterizing part of claim 6.

The invention offers significant benefits.

The water mist does not increase the temperature of the application chamber surfaces, which is the case when blowing steam into the application chamber. The operation and equipment expenses of water spraying are lower compared with blowing moist air or steam. Furthermore, the fine water mist effectively moistens the air in the application chamber, whereby it is easier for the moisture to condensate on the surfaces. In addition, an extremely thin aqueous layer is formed on the web before the coating mix mist is sprayed, increasing the surface energy of the surface, which in turn contributes to the formation of a uniform liquid film on the surface of the web when applying the coating mix.

In the following, the invention is described in detail with the aid of the appended drawing, which is a schematic cross-sectional view of one spray coating unit according to the invention.

The application devices of a spray coating unit 1 are placed inside a casing 2, which divides off the parts of the unit from a surrounding PI. In casing 2, there are three intercommunicating spaces: an application chamber P2, a suction chamber P3 and a beam chamber P4. A web 3 is arranged to travel vertically through the casing 2. In this position, it is easier to prevent mist from condensing into drops in the free airspace, and to collect the mist in the application chamber P2 and the treating agent condensed on the walls thereof, so that no agent in a liquid form or as large condensed drops is allowed to the web 3.

The web 3 to be coated is taken to the application chamber P2 through an inlet opening 4, after which a coating mixture is applied on the surface of the web 3 by means of spray nozzles 6. After the application, the web 3 is taken out of the application chamber P2 through an outlet opening 5.

The application chamber P2 is mainly limited by runoff plates 7, between which the web is arranged to travel. The application chamber P2 is closed at its sides by side blades (not shown), which comprise suction channels for the removal of any coating that misses the web. On the opposite sides of the runoff plates 7 to the web there are partitions 8, behind which there are nozzle beams 9 placed in the beam chamber P4. The nozzle beams 9 have spray nozzles 6 attached thereto, extending through the holes in the partitions 8 at least to the level of the runoff plate 7, and preferably through the same and into the application chamber P2. In the casing 2, there is at least one row of nozzles placed in the cross direction of the web, comprising at least one nozzle 6. Nozzles 6 may be provided on one side of the web 3 or on both sides of the web 3. In the embodiment of the drawing, the application unit comprises two superimposed nozzle beams 9 and rows of nozzles on both sides of the web 3.

The application of the coating mix or some other treating agent is carried out, typically, by feeding the coating mix to the nozzles 6 by means of a high pressure of about 30-180 bar. When the coating mix exits the small outlet opening of a diameter of about 0.25-0.4 mm at the tip of the nozzle 6, it reaches a velocity of about 100 m/s, is atomized into droplets and spreads out into a fan-shaped spray defined by the shape of the nozzle opening. The coating mist impinges the surface of the web 3 that travels in front of the nozzle 6 at a distance from the tip of the nozzle 6. Typically, the spray coating unit 1 has at least one row of nozzles in the travel direction of the web 3. The nozzles in the row of nozzles are typically spaced by 20-200 mm from each other in the cross direction of the web 3. In the cross direction, the areas of impact of adjacent nozzles 6 can be separate or they can be partially overlapping. Typically, the distance of the tip of the nozzle 6 from the web 3 is 10-200 mm. When using two or more rows of nozzles, the spraying order of the rows can be alternated because of washing or maintenance, for example, as is done in the embodiments presented in the figures, wherein the coating mixture is applied from one row of nozzles only, while the second row of nozzles is washed in the beam chamber P4.

Between the runoff plate 7 and the partition 8, a suction chamber P3 is formed, wherein the pressure is kept lower than that in the application chamber P2 and the beam chamber P4. In the upper part of the suction chamber P3, there are one or more nozzles 10 for spraying an agent used for the removal of possible accumulation in the suction chamber P3 and the suction channel 11 in its lower part.

The web 3 tends to carry along treating agent mist and air. The coating mist cannot be allowed to exit the application chamber P2. The outlet side of the web 3 is closed by gas knives 12 that are placed on both sides of the outlet opening 5, intercommunicating with overpressure chambers 13. The gas, usually air, which is blown out of the nozzle openings of the gas knives 12, prevents the coating mix mist from spreading into the environment. The needed pressure is generated in the overpressure chambers 13 by means of a blower or a pump, and the overpressure is typically 100-6000 Pa with respect to the ambient P1 pressure.

The spray coating unit 1 is divided into at least two and preferably three chambers P2, P3 and P4, which are separated from the ambient P1 pressure. In order to prevent the treating agent from flowing into the environment, the pressure in the application chamber P2 must be lower than the ambient P1 pressure and higher than the pressure in the suction chamber P3; at the same time, any mist and condensed liquid substances accumulated in the application chamber can be collected. To prevent the entry of the treating agent mist into the device, the pressure in the beam chamber P4 is preferably higher than that in the suction chamber P3. The parts above the nozzle rows of the runoff plate 7 are cooled down to a temperature below the condensation point of the condition prevailing in the application chamber. In that case, treating agent is condensed from the mist on the cooled surfaces, flowing downwards along the plate. The flowing liquid film collects mist and prevents the treating agent from drying or solidifying into a solid substance on the surface of the plate.

One or more nozzles 15 are attached to the upper edge of the runoff plate 7 on both sides of the web 3, fine water mist being blown from the nozzles towards the inner part of the application chamber P2. The water spray sprayed from the nozzles 15 is dispersed into an average drop size of not more than 150 μm, preferably not more than 50 μm. The nozzles 15 have members for dispersing the water spray into a desired average drop size. In practice, the water spray is atomized so that water is fed into the nozzle 15, for example, by means of a pump at a sufficiently high pressure. The diameter of the orifice of the nozzle 15 is small, whereby the water spray is atomized into droplets when travelling through the orifice. The desired average drop size is reached, when the pressure of the water fed into the nozzle 15 is 20-70 bar and the diameter of the orifice of the nozzle 15 is 0.05-0.2 mm.

Alternatively, water can be atomized into drops by means of compressed air that is lead into the nozzle 15. Water can also be atomized into drops with the aid of an oscillating crystal placed in the nozzle 15. The crystal that oscillates at a high frequency of about 40 kHz, for example, atomizes the water into droplets in the nozzle 15. The drop size of the water mist thus formed is smaller than that in a atomization carried out by water pressure or air pressure only, which is why the mist spreads more evenly in the application chamber P2. The average drop size of the water mist formed by the oscillator is typically 1-20 μm. The drop size can be adjusted by changing the oscillation frequency of the oscillator. Water can also be dispersed into mist by means of ultrasound. Ultrasonic dispersion is carried out, for example, so that water is lead into a water basin, where ultrasonic converters have been installed, dispersing the water in the basin into water mist, which is conveyed to the application chamber P2 by means of air or some other gas that is blown over the water basin. In ultrasonic atomization, the device described in U.S. Pat. No. 5,300,260 can be used, for example.

The amount of water sprayed into the application chamber P2 form the nozzles 15 is preferably so large that the moisture content of the air in the application chamber becomes so high that its condensation temperature is higher than the temperature of the surfaces that come into contact with air. In that case, the moisture of the air in the application chamber P2 condenses effectively on the surfaces of the application chamber. Typically, sufficient moisture content is reached, when the amount of water sprayed into the application chamber is 5-10 g per cubic meter of air coming to the application chamber P2.

Typically, nozzles 15 are placed in the vicinity of the inlet opening 4 of the web 3 so that there are several nozzles 15 on both sides of the web 3, being placed next to each other in the cross direction of the web 3. If treating agent is applied on both surfaces of the web 3, water mist is sprayed into the application chamber P2 on both sides of the web 3. If treating agent is applied on the one side of the web 3 only, water mist can be sprayed into the application chamber P2 through the nozzles on the side of the web 3 that is treated only. Typically, the distance between adjacent nozzles 15 is about 120 mm and the amount of water sprayed from one nozzle 15 is 2-4 l/h.

1. A spray coating unit for treating a moving paper or board web with a treating agent, the spray coating unit comprising:
an application chamber through which the web to be treated is arranged to travel, the application chamber comprising an inlet opening for leading the web into the application chamber and an outlet opening for leading the web out of the application chamber;
at least one row of nozzles comprising at least one nozzle for spraying the treating agent on the surface of the web in the application chamber; and
spraying members for spraying water mist into the application chamber.

2. The spray coating unit of claim 1, wherein the spraying members are provided with members for atomizing water mist into an average drop size of no more than 150 μm.

3. The spray coating unit of claim 1, wherein the spraying members are located in the vicinity of the inlet opening at least on one side of the web.

4. The spray coating unit of claim 3, wherein the spraying members are located in the vicinity of the inlet opening on both sides of the web.

5. The spray coating unit of claim 1, wherein the spraying members comprise nozzles that are fitted next to each other in the cross direction of the web.

6. A method for treating a movable paper or board web with a treating agent, comprising:
taking the web into an application chamber through an inlet opening;
spraying the treating agent on the surface of the web in the application chamber;
bringing the web (3) out of the application chamber (P2) through the outlet opening; and
spraying water mist into the application chamber.

7. The method of claim 6, wherein an average drop size of the water mist sprayed into the application chamber is not more than 150 μm.

8. The method of claim 6, wherein the water mist is sprayed in the vicinity of the inlet opening at least on one side of the web.

9. The method of claim 8, wherein the water mist is sprayed to the vicinity of the inlet opening on both sides of the web.

10. The spray coating unit of claim 1, wherein the spraying members are provided with members for atomizing water mist into an average drop size of no more than 50 μm.

11. The spray coating unit of claim 2, wherein the spraying members are located in the vicinity of the inlet opening at least on one side of the web.

12. The spray coating unit of claim 11, wherein the spraying members are located in the vicinity of the inlet opening on both sides of the web.

13. The method of claim 6, wherein an average drop size of the water mist sprayed into the application chamber is not more than 50 μm.

14. The method of claim 7, wherein the water mist is sprayed in the vicinity of the inlet opening at least on one side of the web.

15. The method of claim 14, wherein the water mist is sprayed to the vicinity of the inlet opening on both sides of the web.
